(19) United States
(12) Patent Application Publication
(10) Pub. No.: US 2005/0237336 A1
(43) Pub. Date: Oct. 27, 2005

(54) Method and system for multi-object volumetric data visualization

(76) Inventors: Jens Guhring, Langensendelbach (DE); Sebastian Vogt, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/110,414

(22) Filed: Apr. 20, 2005

Related U.S. Application Data
(60) Provisional application No. 60/564,935, filed on Apr. 23, 2004.

(51) Int. Cl. G09G 5/00

(52) U.S. Cl. 345/582

(57) ABSTRACT

A method of rendering volumetric digital images including the steps of providing one or more digital images representing objects with known spatial relation to each other, associating a texture with each object (digital image), choosing a viewing direction for said rendering, imposing a single proxy geometry on all of the one or more textures, and resampling each of the one or more textures using coordinates generated by the single proxy geometry. The range of the coordinate system generated by said proxy geometry extends beyond the valid range of a texture coordinate. The range of the proxy geometry coordinates can be checked to determine which objects provide a valid contribution to the rendering.

### CROSS REFERENCE TO RELATED UNITED STATES APPLICATIONS

This application claims priority from “Multi-Object Volumetric Data Visualization”, U.S. Provisional Application No. 60/564,935 of Guehring, et al., filed Apr. 23, 2004, the contents of which are incorporated herein by reference.

### TECHNICAL FIELD

This invention is directed to the visualization digital medical image datasets.

### DISCUSSION OF THE RELATED ART

The diagnostically superior information available from data acquired from current imaging systems enables the detection of potential problems at earlier and more treatable stages. Given the vast quantity of detailed data acquirable from imaging systems, various algorithms must be developed to efficiently and accurately process image data. With the aid of computers, advances in image processing are generally performed on digital or digitized images.

Digital images are created from an array of numerical values representing a property (such as a grey scale value or magnetic field strength) associable with an anatomical location points referenced by a particular array location. The set of anatomical location points comprises the domain of the image. In 2-D digital images, or slice sections, the discrete array locations are termed pixels. Three-dimensional digital images can be constructed from stacked slice sections through various construction techniques known in the art. The 3-D images are made up of discrete volume elements, also referred to as voxels, composed of pixels from the 2-D images. The pixel or voxel properties can be processed to ascertain various properties about the anatomy of a patient associated with such pixels or voxels.

The efficient visualization of volumetric datasets is important for many applications, including medical imaging, finite element analysis, mechanical simulations, etc. Nowadays, a variety of volume rendering techniques are available. Many of these techniques rely on the mapping of texture data onto a proxy geometry. The mapping is defined by texture coordinates, which are attached to the vertices defining the proxy geometry. Typically, these texture coordinates are chosen to reference valid positions within the texture data, requiring the proxy geometry to adapt to the extends of the dataset. To achieve high frame-rates, most techniques imply the use of graphics hardware acceleration for texture mapping. However, the combined rendering of multiple objects involves extra considerations, since it requires a coordinated way to render multiple proxy geometries.

### SUMMARY OF THE INVENTION

Exemplary embodiments of the invention as described herein generally include methods and systems for rendering volumetric data based on a specific configuration of proxy geometry and texture coordinates.

According to an aspect of the invention, there is provided a method for rendering one or more volumetric digital images comprising the steps of providing one or more digital images comprising a plurality of intensities corresponding to a domain of points in a 3-dimensional space, wherein each digital image is in a known spatial relationship with each other digital image, associating a texture with each image, choosing a viewing direction for said rendering, imposing a single proxy geometry on all of the one or more textures, resampling each of the one or more textures using coordinates generated by the single proxy geometry, and combining the value corresponding to each of the one or more textures to generate a pixel of a 2-dimensional rendered image.

According to a further aspect of the invention, each image comprises an object selected based on intensity value ranges in the digital images.

According to a further aspect of the invention, the range of the coordinate system generated by said proxy geometry extends beyond the valid range of a texture coordinate.

According to a further aspect of the invention, a coordinate system for the proxy geometry is generated for each texture to be rendered, wherein range of each coordinate system is referenced to the coordinate system of each texture.

According to a further aspect of the invention, the method further comprising checking the range of the proxy geometry coordinate system to determine which of the one or more textures provides a valid contribution to the rendering.

According to a further aspect of the invention, the method further comprises, when two or more textures overlap, invoking a rule to determine how to render a pixel in the overlapped region.

According to a further aspect of the invention, the rules include arithmetic operations, thresholding, masking, indexing, classification, blending, shading, and clipping.

According to a further aspect of the invention, the method further comprises utilizing a graphical processing unit to perform the combining of the textures.

According to a further aspect of the invention, the rendering further comprises a multi-planar reconstruction.

According to a further aspect of the invention, the rendering further comprises a maximum intensity projection.

According to a further aspect of the invention, the rendering further comprises a direct-volume rendering algorithm.

According to a further aspect of the invention, the method further comprises applying a transfer function to each texture value to determine the value corresponding to each texture.

According to another aspect of the invention, there is provided a program storage device readable by a computer, tangibly embodying a program of instructions executable by the computer to perform the method steps for rendering one or more volumetric digital images.

### BRIEF DESCRIPTION OF THE DRAWINGS

FIG. 1 depicts a comparison of dataset bound proxy geometries with a combined proxy geometry, according to an embodiment of the invention.

FIG. 2 depicts a flow chart of a combined proxy geometry method according to an embodiment of the invention.

FIG. 3 is a block diagram of an exemplary computer system for implementing a volumetric data visualization scheme, according to an embodiment of the invention.

### DETAILED DESCRIPTION OF THE PREFERRED EMBODIMENTS

Exemplary embodiments of the invention as described herein generally include systems and methods for visualizing multi-object volumetric data. In the interest of clarity, not all features of an actual implementation which are well known to those of skill in the art are described in detail herein.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

The term volume rendering refers to a set of techniques for rendering, or displaying, three-dimensional volumetric data onto a two-dimensional display image. A fundamental operation in volume rendering is the sampling of volumetric data. Since this data is already discrete, the sampling task performed during rendering is a resampling of sampled volume data from one set of discrete locations to another. In order to render a high quality image of the entire volume, the resampling locations should be chosen carefully, followed by mapping the obtained intensity values to optical properties, such as color and opacity, and compositing them in either front-to-back or back-to-front order.

Texture mapping involves the application of a type of surface to a 3-dimensional image, and typically refers to a sequence of operations performed by a graphical processing unit. A texture can be regarded as a 2D or 3D array of color values or grey-scale values, whose coordinates are in the range of 0.0 to 1.0. Since an actual array in memory will be stored as, e.g., an N % M array for a 2D texture, the graphics processing unit will convert the respective coordinate values to a number in the range (0 . . . N−1), or (0 . . . M−1), as the case might be. The graphics operations resample a discrete grid of texels to obtain texture values at locations that do not coincide with the original grid. The resampling locations are generated by rendering a proxy geometry imposed on the original volume grid with interpolated texture coordinates, which are usually comprised of slices rendered as texture-mapped quads, and compositing all of the slices of the proxy geometry from front-to-back. The volume data itself can be stored in one or more textures of two or three dimensions.

When considering the three-dimensional data that comprises the image volume data, one can imagine imposing a geometric object on this field. When this geometric object is rendered, attributes such as texture coordinates can be interpolated over the interior of the object, and each graphic fragment generated can be assigned a corresponding set of texture coordinates. These coordinates can be used for resampling the one or more textures at the corresponding locations. If one assigns texture coordinates that correspond to the coordinates in the scalar image field, and store the image field itself in one or more texture maps, that field can be sampled at arbitrary locations as long as these are obtained from the interpolated texture coordinates. The collection of geometric objects used for obtaining all resampling locations needed for sampling the entire volume is referred to as a proxy geometry, as it has no inherent relation to the data contained in the image volume itself, and exists for the purpose of generating resampling locations, and subsequently sampling texture maps at these locations.

One example of proxy geometry is a set of view-aligned slices that are quads parallel to the viewport, usually clipped against the bounding box of the image volume. These slices include 3D texture coordinates that are interpolated over the interior of the slices, and can be used to sample a single 3D texture map at the corresponding locations. A proxy geometry is closely related to the type of texture mapping, i.e., 2D or 3D, being used. When the orientation of slices with respect to the original image volume data can be arbitrary, a 3D texture mapping is needed since a single slice would have to fetch data from several 2D textures. If, however, the proxy geometry is aligned with the original volume data, texture fetch operations for a single slice can be guaranteed to stay within the same 2D texture. In this case, the proxy geometry comprises a set of object-aligned slices for which 2D texture mapping capabilities suffice.

Thus, by rendering geometric objects mapped with textures, the original volume can be sampled at specific locations, blending the generated pixels with previously generated pixels. These generated pixels are sometimes referred to as fragments. Such an approach does not iterate over individual pixels of the image plane, but over “parts” of the object. These parts are usually included in the slices through the volume, and the final result for each pixel is available only after all slices contributing to a given pixel have been processed.

According to an embodiment of the invention, a single combined proxy geometry can be used to visualize multiple objects, instead of using multiple proxy geometries, i.e. one for each object being visualized. The vertices of the combined proxy geometry can have different texture coordinates for each individual object, a property referred to as multitexturing. Since the new proxy geometry is no longer bound to the actual extends of the datasets, texture coordinates are not restricted to referencing valid positions within the associated texture. This adds flexibility to the choice of proxy geometries and enables more complex methods for visualizing the fused datasets.

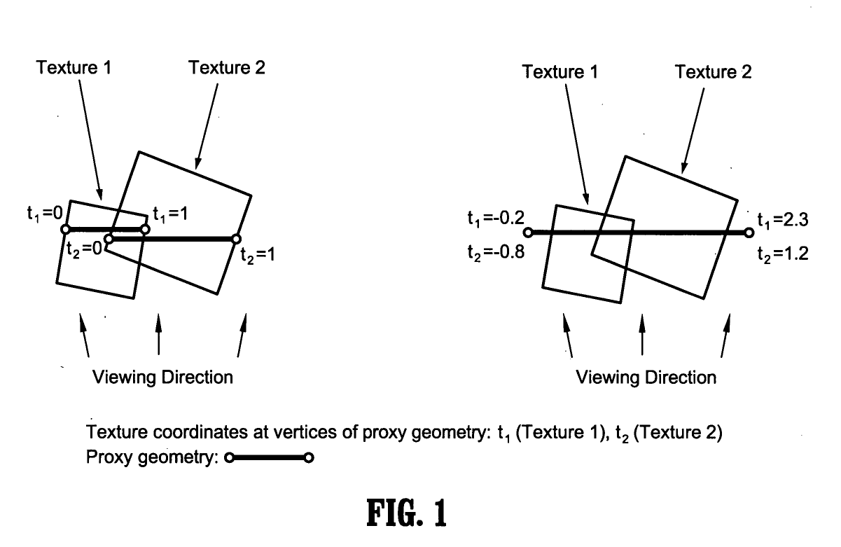

A comparison of dataset bound proxy geometries with a combined proxy geometry, according to an embodiment of the invention, is illustrated in FIG. 1. On the left side are depicted two textures, labeled as Texture 1 and Texture 2, each of which would be used to map a distinct object in an image volume. Each texture has its own proxy geometry aligned with a viewing direction, represented by a thick line drawn through the texture. This diagram should be regarded as a top view, so that the proxy geometries are actually 2D planes or slabs perpendicular to the plane of the diagram. Each proxy geometry is terminated on the left side of its respective texture, at texture coordinate 0.0, and on the right side of its respective texture, at texture coordinate 1.0. The diagram illustrates the overlap of the two proxy geometries that needs to be considered when rendering the two objects. A combined proxy geometry for rendering both textures is depicted on the right side of the diagram. According to an embodiment of the invention, the graphics subsystem can be configured to map texture references outside the valid texture to a defined background value, which can be transparent. In this embodiment, a texture coordinate can have a negative value, or a value greater than 1.0. Present day graphics libraries permit users to define coordinates having these ranges, and allow the user to specify the values assumed by the texture in these ranges. Referring to the figure, the combined proxy geometry depicted in the diagram extends beyond the edges of the two textures. This combined proxy geometry can be assigned texture coordinates in reference to either Texture 1 or Texture 2. The t₁ values, −0.2 for the left edge, and 2.3 for the right edge, refer to Texture 1, while the t₂ values, −0.8 and 1.2, respectively, refer to Texture 2. Extending the proxy geometry beyond the edge of the texture enables easier rendering of a texture that is not aligned with the viewing direction. The fusion of the different textures can be performed by means provided by the graphics processor.

Typical graphics subsystems allow programmability within two stages of the graphics pipeline, the vertex and fragment shaders. According to an embodiment of the invention, a fragment shader can be used to combine texture datasets on a pixel-by-pixel basis, giving full control over the fusion of data. Hence, a system of rules ranging from the simple to the complex can be realized for combining the values of the individual texture datasets. Such rules can include arithmetic operations, thresholding, masking, indexing, classification, blending, shading, clipping, etc. By checking the range of the texture coordinates, it can easily be determined which datasets have a valid contribution to the fused result. For example, referring again to FIG. 1, if the t₁ coordinate of the proxy geometry is within a valid texture range, but the t₂ is not, then the texture value from Texture 1 contributes to the final result. Similarly, if the t₂ coordinate of the proxy geometry is within a valid texture range, but the t₁ is not, then the texture value from Texture 2 contributes to the final result. If both the t₁ and t₂ coordinates are within the valid range, then both textures contribute to the final result, and one of the rules would be used to determine the relative contribution of each texture value. Finally, if neither coordinate is within a valid range, then neither texture contributes to the final rendering result.

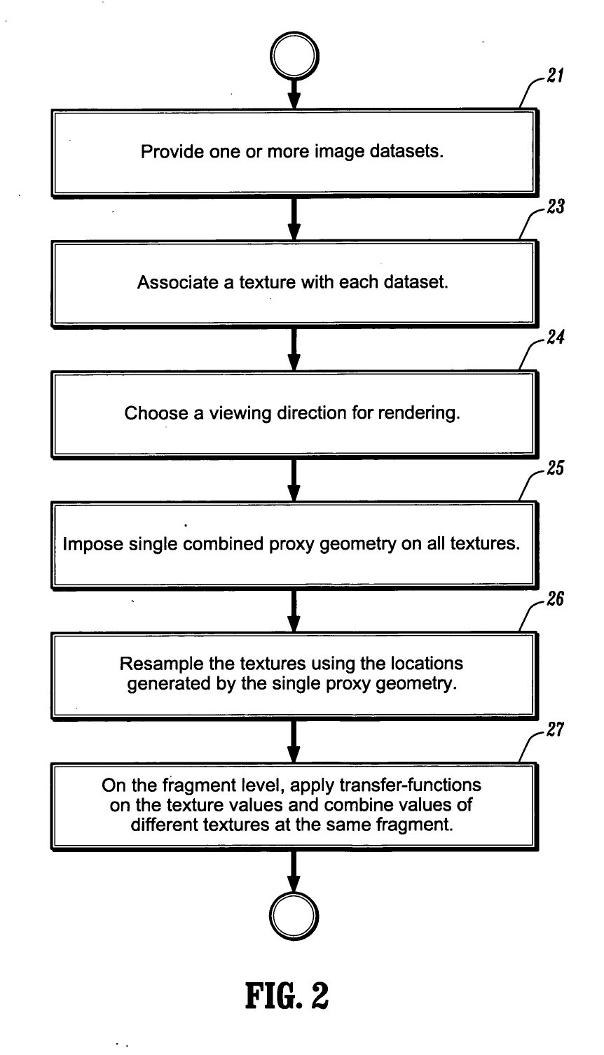

A flow chart of a combined proxy geometry method according to an embodiment of the invention is depicted in FIG. 2. One or more 3D image datasets are provided at step 21, where each dataset represents one object. The spatial relationships of the one or more objects with respect to each other is known so that the datasets can be placed correctly relative to each other for rendering purposes. At step 23, a texture map is associated with each object to be rendered. A viewing direction for the 2D rendering is selected at step 24. At step 25, a single proxy geometry is imposed on the one or more objects. The proxy geometry can generate one or more coordinate systems so there can be a coordinate system referenced to each object and texture. At step 26, the textures are resampled using the coordinates generated by the single proxy geometry. At step 27, the resampled texture values of the different textures at a particular location are used to determine how to color the fragment. In many imaging modalities, such as CT or MRI, the resulting intensity values, which are stored as texture values in this embodiment of the invention, can be correlated with specific types of tissue, enabling one to discriminate, for example, bone, muscle, flesh, and fat tissue, nerve fibers, blood vessels, organ walls, etc., based on the intensity ranges within the image. The raw intensity values in the image, which are fetched from the texture during the rendering process, can serve as input to a transfer function whose output is an opacity value that can characterize the type of tissue. These opacity values can be used to define a look-up table where an opacity value that characterizes a particular type of tissue is associated with each pixel point. In an embodiment of this invention, the look-up table can be implemented by using texture-dependent look-up capabilities of current graphics hardware, where an additional texture can represent the look-up table and which is applied after the values have been fetched from the textures that represent the image, or by using programmable fragment shaders. The use of opacity values to classify tissue also enables a user to select a tissue type to be displayed. By comparison of the different coordinates of a point in the proxy geometry, as discussed above, one can determine, e.g., whether two or more objects overlap. If there is an overlap, the rules for combining contributions can be invoked to determine how to render the pixel or fragment.

According to another embodiment of the invention, the programmability of graphics hardware can be used to accelerate the rendering.

Many different rendering algorithms can incorporate one or more embodiments of the invention. A non-limiting lets of these rendering algorithms includes multi-planar reconstructions (MPRs), maximum intensity projections (MIPs), and direct volume rendering methods.

According to another embodiment of the invention, a visualization probe that can be positioned arbitrarily in an image volume utilizes a combined proxy geometry. The proxy geometry used to implement the probe can be defined independent from the scene contents. Examples of such proxy geometries include an arbitrary rectangle for generating a planar MPR, and a view-aligned stack of rectangles for directly rendering a sub-volume. A visualization probe can provide a means to visualize a 3D dataset, and would behave like a mouse that can move around in a 3D space, and can find application in, e.g., augmented reality or interactive, screen-based visualization methods of multiple datasets that are spacially correlated. For example, a planar rectangle can be attached to the probe, and can form the basis of a proxy geometry centered on a cursor in 3D space. When a user moves the 3D curser, a 2D cut of the overall volume can be obtained where the 2D cut is aligned with the proxy geometry of the probe and thus cuts through all datasets in a way as described above. A visualization probe incorporating a proxy geometry according to an embodiment of the invention can provide real-time interactive visualization of multiple datasets and their spatial relation to each other based on a user moving the probe.

Although the embodiments of the invention have been described herein in the context of multi-object data visualization, a proxy geometry according to another embodiment of the invention can be applied to single dataset visualization. This embodiment provides extra flexibility in the choice of a suitable proxy geometry and the use of a framework that generalizes to multiple texture datasets.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

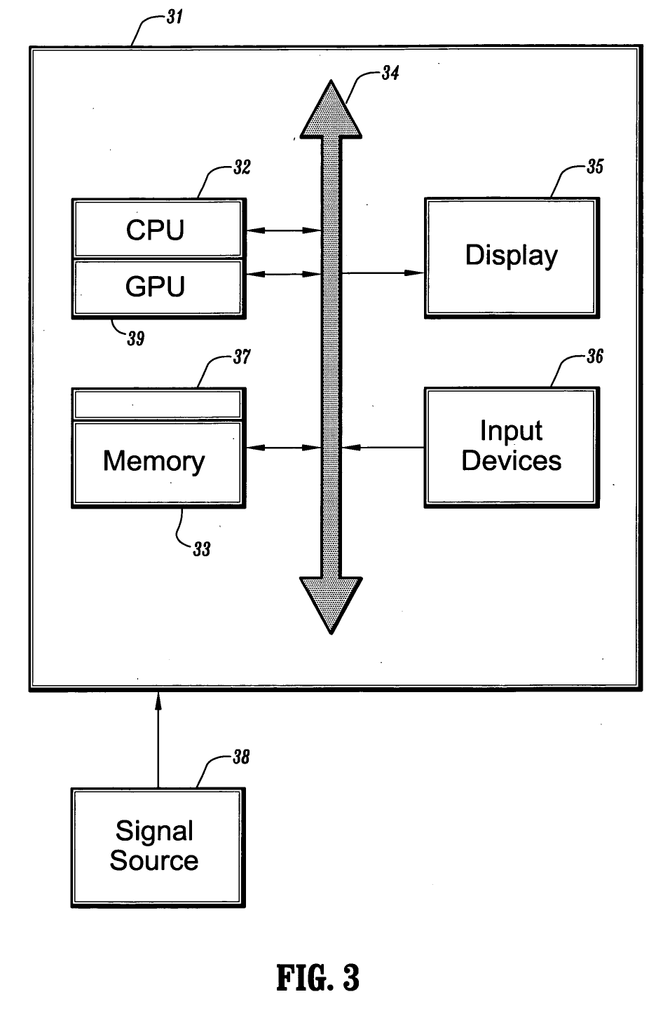

Referring now to FIG. 3, according to an embodiment of the present invention, a computer system 31 for implementing the present invention can comprise, inter alia, a central processing unit (CPU) 32, a graphics processing unit (GPU) 39, a memory 33 and an input/output (I/O) interface 34. The computer system 31 is generally coupled through the I/O interface 34 to a display 35 and various input devices 36 such as a mouse and a keyboard. The support circuits can include circuits such as cache, power supplies, clock circuits, and a communication bus. The memory 33 can include random access memory (RAM), read only memory (ROM), disk drive, tape drive, etc., or a combinations thereof. The present invention can be implemented as a routine 37 that is stored in memory 33 and executed by the CPU 32, and supported by hardware accelerated graphics rendering by GPU 39, to process a signal from a signal source 38. As such, the computer system 31 is a general purpose computer system that becomes a specific purpose computer system when executing the routine 37 of the present invention.

The computer system 31 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of rendering one or more volumetric digital images, said method comprising the steps of:
providing one or more digital images comprising a plurality of intensities corresponding to a domain of points in a 3-dimensional space, wherein each digital image is in a known spatial relationship with each other digital image;
associating a texture with each image;
choosing a viewing direction for said rendering;
imposing a single proxy geometry on all of the one or more textures;
resampling each of the one or more textures using coordinates generated by the single proxy geometry; and
combining the value corresponding to each of the one or more textures to generate a pixel of a 2-dimensional rendered image.

2. The method of claim 1, wherein each image comprises an object selected based on intensity value ranges in the digital images.

3. The method of claim 1, wherein the range of the coordinate system generated by said proxy geometry extends beyond the valid range of a texture coordinate.

4. The method of claim 3, wherein a coordinate system for the proxy geometry is generated for each texture to be rendered, wherein range of each coordinate system is referenced to the coordinate system of each texture.

5. The method of claim 3, further comprising checking the range of the proxy geometry coordinate system to determine which of the one or more textures provides a valid contribution to the rendering.

6. The method of claim 5, further comprising, when two or more textures overlap, invoking a rule to determine how to render a pixel in the overlapped region.

7. The method of claim 6, wherein said rules include arithmetic operations, thresholding, masking, indexing, classification, blending, shading, and clipping.

8. The method of claim 1, further comprising utilizing a graphical processing unit to perform the combining of the textures.

9. The method of claim 1, wherein said rendering further comprises a multi-planar reconstruction.

10. The method of claim 1, wherein said rendering further comprises a maximum intensity projection.

11. The method of claim 1, wherein said rendering further comprises a direct-volume rendering algorithm.

12. The method of claim 1, further comprising applying a transfer function to each texture value to determine the value corresponding to each texture.

13. A method of visualizing a volumetric digital image, said method comprising the steps of:
providing a digital image comprising a plurality of intensities corresponding to a domain of points in a 3-dimensional space;
selecting a subset of said image for visualization;
choosing a viewing direction for said viewing said subset of said image;
imposing one or more textures on said image subset selected for viewing;
imposing a single proxy geometry on said one or more textures, wherein the range of a coordinate system generated by said proxy geometry extends beyond the valid range of a texture coordinate;
resampling each of the one or more textures using coordinates generated by the single proxy geometry;
combining the value corresponding to each of the one or more textures to create a 2-dimensional rendering of said image; and
displaying said rendering on a display device.

14. The method of claim 13, further comprising selecting a new subset of said image for visualization, and repeating said steps of choosing a viewing direction, imposing one or more textures, imposing a single proxy geometry on said textures, resampling each of the one or more textures, combining the value corresponding to each of the one or more textures to create a 2-dimensional rendering, and displaying said rendering on a display device.

15. A program storage device readable by a computer, tangibly embodying a program of instructions executable by the computer to perform the method steps for rendering one or more volumetric digital images, said method comprising the steps of:
providing one or more digital images comprising a plurality of intensities corresponding to a domain of points in a 3-dimensional space, wherein each digital image is in a known spatial relationship with each other digital image;
associating a texture with each image;
choosing a viewing direction for said rendering;
imposing a single proxy geometry on all of the one or more textures;
resampling each of the one or more textures using coordinates generated by the single proxy geometry; and
combining the value corresponding to each of the one or more textures to generate a pixel of a 2-dimensional rendered image.

16. The computer readable program storage device of claim 15, wherein each image comprises an object selected based on intensity value ranges in the digital images.

17. The computer readable program storage device of claim 15, wherein the range of the coordinate system generated by said proxy geometry extends beyond the valid range of a texture coordinate.

18. The computer readable program storage device of claim 17, wherein a coordinate system for the proxy geometry is generated for each texture to be rendered, wherein range of each coordinate system is referenced to the coordinate system of each texture.

19. The computer readable program storage device of claim 17, the method further comprising checking the range of the proxy geometry coordinate system to determine which of the one or more textures provides a valid contribution to the rendering.

20. The computer readable program storage device of claim 19, the method further comprising, when two or more textures overlap, invoking a rule to determine how to render a pixel in the overlapped region.

21. The computer readable program storage device of claim 20, wherein said rules include arithmetic operations, thresholding, masking, indexing, classification, blending, shading, and clipping.

22. The computer readable program storage device of claim 15, the method further comprising utilizing a graphical processing unit to perform the combining of the textures.

23. The computer readable program storage device of claim 15, wherein said rendering further comprises a multi-planar reconstruction.

24. The computer readable program storage device of claim 15, wherein said rendering further comprises a maximum intensity projection.

25. The computer readable program storage device of claim 15, wherein said rendering further comprises a direct-volume rendering algorithm.

26. The computer readable program storage device of claim 15, the method further comprising applying a transfer function to each texture value to determine the value corresponding to each texture.
